(19) United States
(12) Patent Application Publication
(10) Pub. No.: US 2025/0083354 A1
(43) Pub. Date: Mar. 13, 2025

(54) CUTTING PLOTTER AND MEDIUM SUPPORTING DEVICE THEREOF

(71) Applicant: Silhoutte Japan Corporation, Yokohama-shi (JP)

(72) Inventor: Yoshitaka TSUNOI, Yokohama-shi (JP)

(21) Appl. No.: 18/882,375

(22) Filed: Sep. 11, 2024

(30) Foreign Application Priority Data
Sep. 12, 2023 (JP) 2023-147624

(51) Int. Cl. B26D 7/01; B26D 7/00; B26D 7/26

(52) U.S. Cl. CPC B26D 7/015; B26D 7/2628; B26D 2007/0087; B26D 2007/2678

(57) ABSTRACT

The medium supporting device comprises an electrostatic chucking mat generating an electrostatic chucking force by being energized, and a support for supporting the electrostatic chucking mat movably in a first direction. The support is removably connected to a cutting plotter. The cutting plotter includes a medium feeding mechanism for moving a medium reciprocally in the first direction. The electrostatic chucking mat is moved by the medium feeding mechanism while the medium is chucked.

### TECHNICAL FIELD

The present invention relates to a cutting plotter medium supporting device for supporting a medium by electrostatic chucking and a cutting plotter comprising the medium supporting device.

### BACKGROUND ART

There are conventional cutting plotters that can cut a medium well even when the medium is thin, as disclosed in JP 2005-205539 A (document 1). The cutting plotter disclosed in document 1 is provided with a medium supporting sheet for supporting a thin medium in close contact. The cutting plotter feeds a laminate constituted by a medium and a medium supporting sheet in the front-rear direction for cutting.

The medium supporting sheet is of an electrostatic chucking type and includes a flexible plastic sheet, an electrostatic chucking electrode formed on the plastic sheet, and other components. By energizing the electrode, an electrostatic chucking force is generated to cause the cutting medium to adhere onto the plastic sheet. By using the medium supporting sheet, it is possible to easily remove the product portion from the medium after cutting the thin medium.

However, when cutting, there were times when ends in the feed direction of the medium supporting sheet were bent and the medium could not stick together with the medium supporting sheet, causing the medium to rise up. When the medium rises up from the medium supporting sheet, the cutting may fail when the raised portion reaches the cutting position.

### SUMMARY OF THE INVENTION

The present invention aims to provide a cutting plotter medium that can reliably cut a thin medium, and a medium supporting device thereof.

An aspect of the present invention concerns a cutting plotter medium supporting device comprising: a support configured to be removably connected to a cutting plotter provided with a medium feeding mechanism configured to reciprocally move a medium in a first direction; an electrostatic chucking mat configured to be supported by the support movably in the first direction and generate an electrostatic chucking force by being energized, the electrostatic chucking mat being moved by the medium feeding mechanism while the medium is chucked by the electrostatic chucking force.

Another aspect of the present invention concerns a cutting plotter comprising: the medium supporting device; the medium feeding mechanism; a work stage detachably connected to the support of the medium supporting device; and a pen carriage configured to move above the work stage in a second direction which is orthogonal to the first direction and which is parallel to a horizontal direction and support a cutting pen movable in an up-down direction, wherein the medium feeding mechanism is configured to cause the electrostatic chucking mat on which the medium is chucked by the electrostatic chucking force to move reciprocally in the first direction.

### BRIEF DESCRIPTION OF THE DRAWINGS

FIG. 1 shows a perspective view of a cutting plotter on which a medium supporting device is attached according to an embodiment of the present invention.

FIG. 2 shows a cross-sectional view illustrating a medium feeding mechanism when only the medium to be cut is moved.

FIG. 3 shows a cross-sectional view illustrating the medium feeding mechanism when moving an electrostatic chucking mat electrostatically chucking the medium to be cut.

FIG. 4 shows a perspective view illustrating a connecting portion of the cutting plotter.

FIG. 5 shows a plan view of the medium supporting device.

FIG. 6 shows a perspective view of the medium supporting device.

FIG. 7 shows a perspective view of the medium supporting device showing a state in which the electrostatic chucking mat has moved.

FIG. 8 shows a perspective view illustrating an enlarged connecting portion of the medium supporting device.

FIG. 9 shows a perspective cross-sectional view illustrating a positioning structure.

FIG. 10 shows a perspective cross-sectional view illustrating first and second contact terminals.

FIG. 11 shows a perspective cross-sectional view illustrating a locking mechanism before connection.

FIG. 12 shows a perspective cross-sectional view illustrating a locking mechanism after locking.

FIG. 13 shows an exploded perspective view of the medium supporting device.

FIG. 14 shows a perspective cross-sectional view illustrating a portion of the medium supporting device enlarged.

FIG. 15 shows a plan view of a medium supporting device according to another embodiment of the present invention.

FIG. 16 shows a cross-sectional view illustrating the medium feeding mechanism when moving an electrostatic chucking mat electrostatically chucking the medium to be cut.

### DETAILED DESCRIPTION OF THE INVENTION

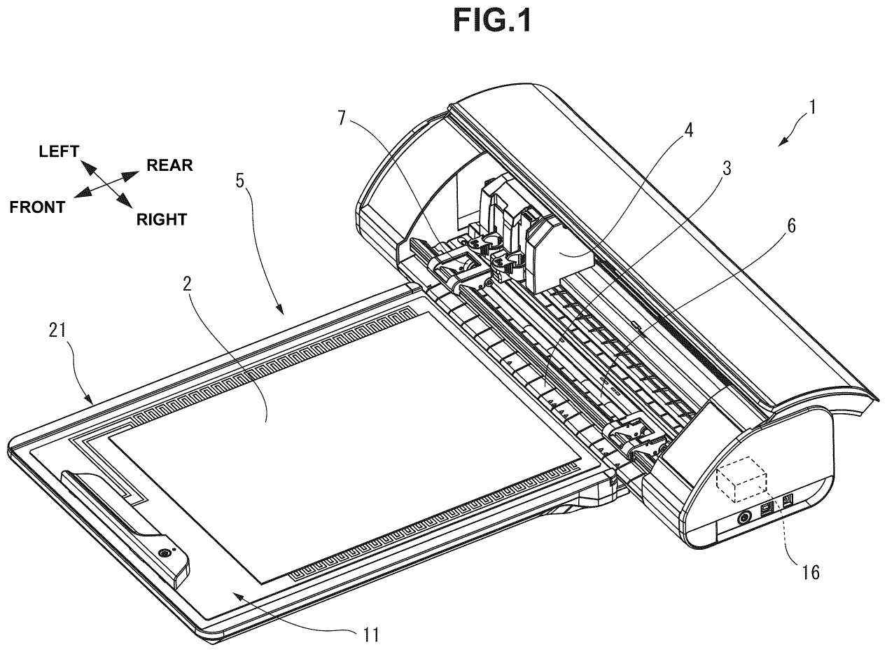

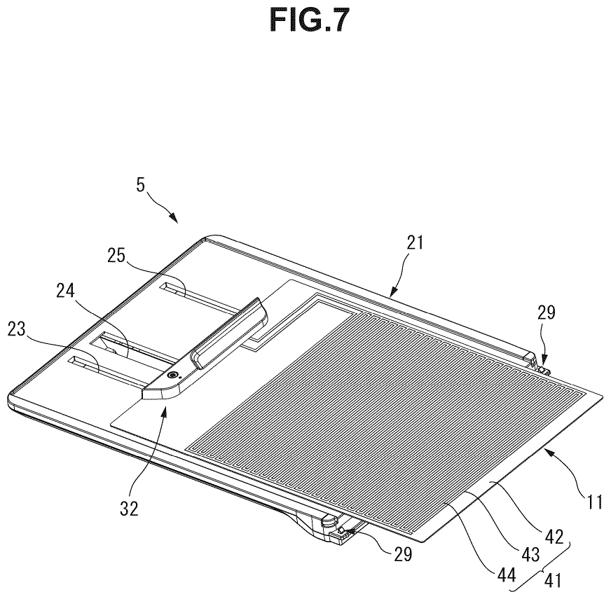

Hereinafter, an embodiment of the present invention will be described in detail with reference to FIGS. 1-14.

The cutting plotter 1 shown in FIG. 1 is for cutting out figures and characters from a sheet-shaped medium 2 to be cut (hereinafter simply referred to as the “medium 2”). The cutting plotter 1 includes a work stage 3 on which the medium 2 is conveyed, and a pen carriage 4 for supporting a cutting pen not illustrated.

The work stage 3 is formed to extend in a conveyance direction (a first direction, which is a direction from the lower left to the upper right in FIG. 1) of the medium 2 and a left-right direction (a second direction, which is a direction from the upper left to the lower right in FIG. 1) orthogonal to the conveyance direction and parallel to the horizontal direction. In the following, the downstream side of the medium 2 in the conveyance direction is referred to as the “rear”, and the upstream side of the medium 2 in the conveyance direction is referred to as the “front”.

The medium 2 may be a single sheet, a rolled sheet, etc. When the medium 2 is a single thin sheet, a medium supporting device 5 is attached to a front end of the work stage 3 of the cutting plotter 1 to cause the medium supporting device 5 to support the medium 2.

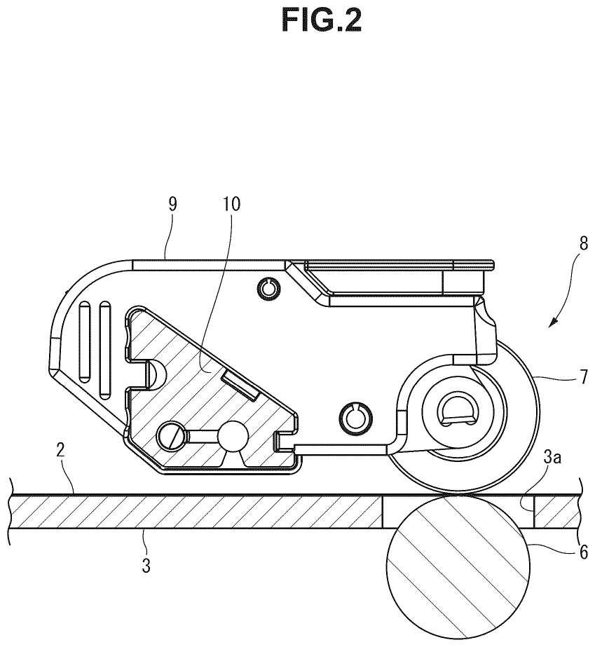

The conveyance of the medium 2 when a medium supporting device 5 is not used is carried out by rotating a medium driving roller 6 while the medium 2 on the work stage 3 is sandwiched between the medium driving roller 6 and a pinch roller 7, as shown in FIG. 2. The medium driving roller 6 and the pinch roller 7 constitute a medium feeding mechanism 8 for causing the medium 2 to reciprocate in the conveyance direction.

The pinch roller 7 is supported by the support member 9 movable in the vertical direction, and is biased so as to be pressed against the medium driving roller 6 by the spring force of a spring member not illustrated. The support member 9 is supported by a frame, not illustrated, of the cutting plotter 1 via a rail 10 extending in the left-right direction.

The medium driving roller 6 is disposed at the lower portion of the work stage 3 and extends in the left-right direction. An opening 3a extending in the left-right direction is formed on the work stage 3, and the upper portion of the medium driving roller 6 protrudes from the opening 3a to the upper surface of the work stage 3. The opening 3a is formed on the front side of the pen carriage 4 described later. The medium driving roller 6 rotates such that the medium 2 pressed by the pinch roller 7 is conveyed.

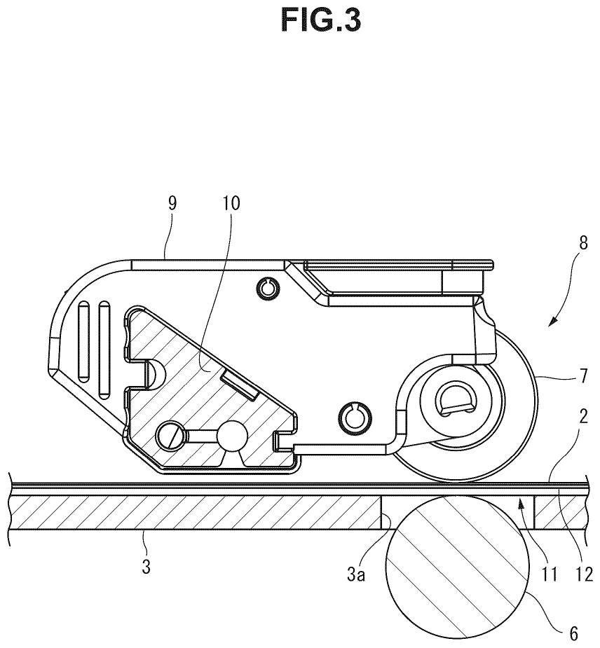

The conveyance of the medium 2 when the medium supporting device 5 is used is carried out by laying a protective sheet 12 on the electrostatic chucking mat 11 of the medium supporting device 5 described later, putting the medium 2 on the protective sheet 12, and sandwiching the laminate between the medium driving roller 6 and the pinch roller 7, as shown in FIG. 3.

The pen carriage 4 has a function of driving the cutting pen (not illustrated) in the up-down direction. The pen carriage 4 is configured to be movable in the left-right direction above the work stage 3. The “up-down direction” herein is a vertical direction intersecting the work stage 3.

In this embodiment, the medium 2 is cut by attaching a cutting pen to the pen carriage 4, rotating the medium driving roller 6 in a forward or reverse direction while the medium 2 is sandwiched between the medium driving roller 6 and the pinch roller 7, and piercing the cutting pen into the medium 2 and moving the cutting pen along with the pen carriage 4 in the left-right direction.

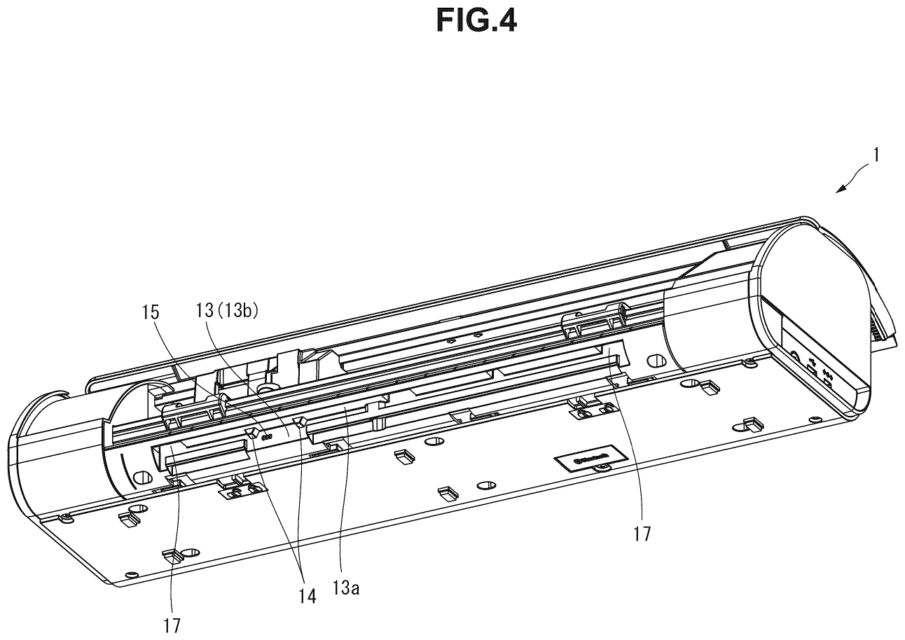

A groove 13 that is open toward forward and downward is formed on the front end of the work stage 3 of the cutting plotter 1 as shown in FIG. 4. When the media supporting device 5 described later is attached to the cutting plotter 1, a part of the rear end of the media supporting device 5 is inserted into this groove 13. The groove 13 serves as a connecting portion to be connected to the medium supporting device 5. The work stage 3 is detachably connected to the support 21 of the medium supporting device 5 via the groove 13.

The groove 13 is defined by an upper wall 13a which faces downward and a bottom wall 13b (a wall of a rear end of the groove 13) which faces forward. A plurality of functional portions for mounting the medium supporting device 5 are provided in the groove 13. A first functional portion is constituted by two convex portions 14 (second structure) protruding in the groove 13. The convex portions 14 are for positioning the medium supporting device 5 when the medium supporting device 5 is installed. The convex portion 14 protrudes downward from the upper wall 13a of the groove 13 and extends in the front-rear direction.

The second functional portion is constituted by a second contact terminal 15 exposed to the outside of the bottom wall 13b of the groove 13. The second contact terminal 15 is for supplying power to the medium supporting device 5. The second contact terminal 15 is formed in a plate shape extending in the up-down direction and left-right direction and is connected to the power supply unit 16 (see FIG. 1) of the cutting plotter 1. The power supply unit 16 is disposed on the back of the bottom wall 13b.

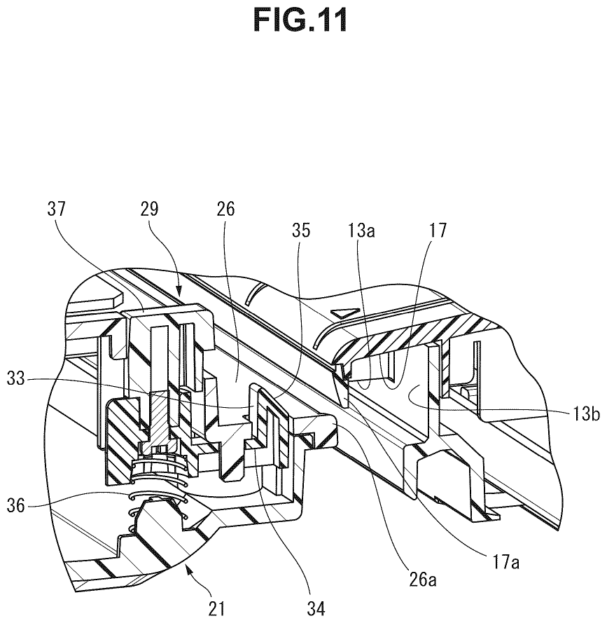

The third functional portion is constituted by two engagement holes 17 formed on both ends of the groove 13 in the left-right direction. The engagement hole 17 is for preventing disengagement by engaging a part of the medium supporting device 5. As shown in FIG. 11, the engagement hole 17 is formed on the upper wall 13a of the groove 13 and is open to downward.

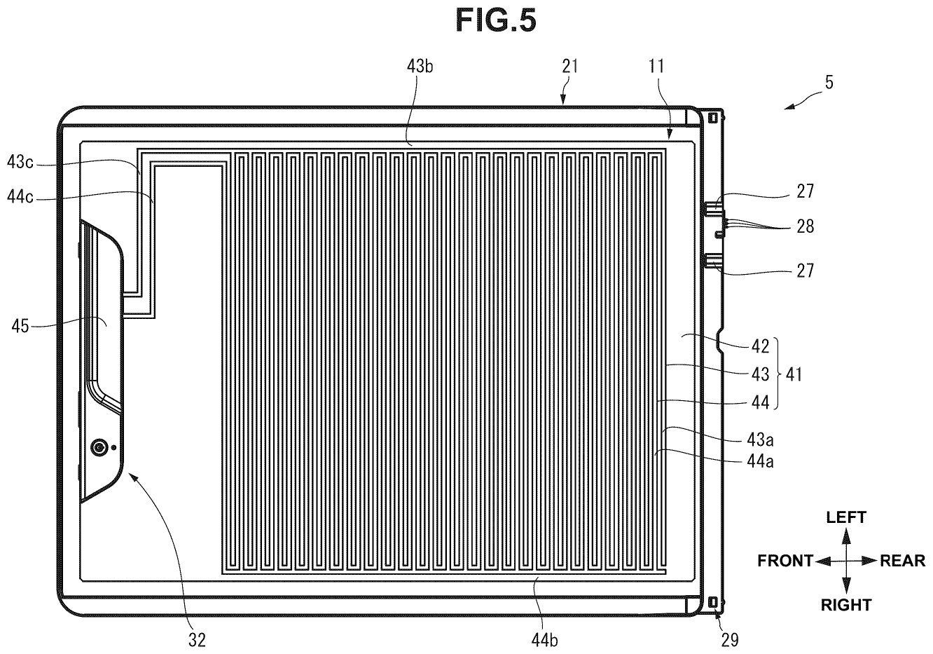

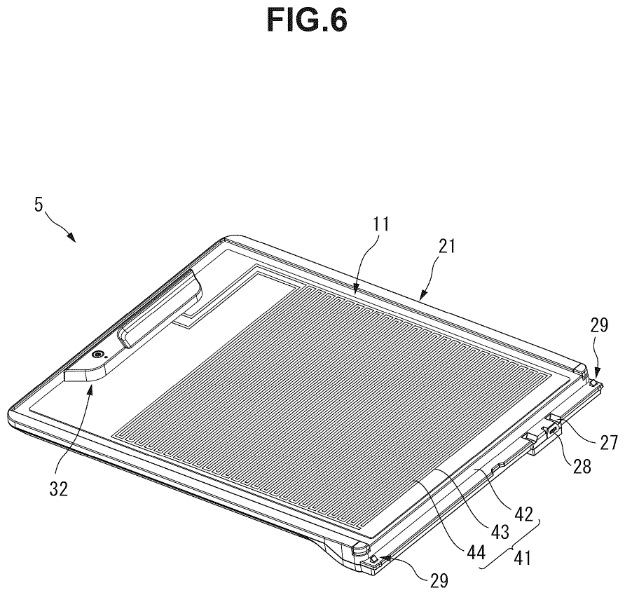

As shown in FIGS. 5 and 6, the medium supporting device 5 includes: a support 21 formed in a rectangular plate shape in a plan view; and an electrostatic chucking mat 11 which is supported by the support 21 movably in the conveying direction (front-rear direction) of the medium 2.

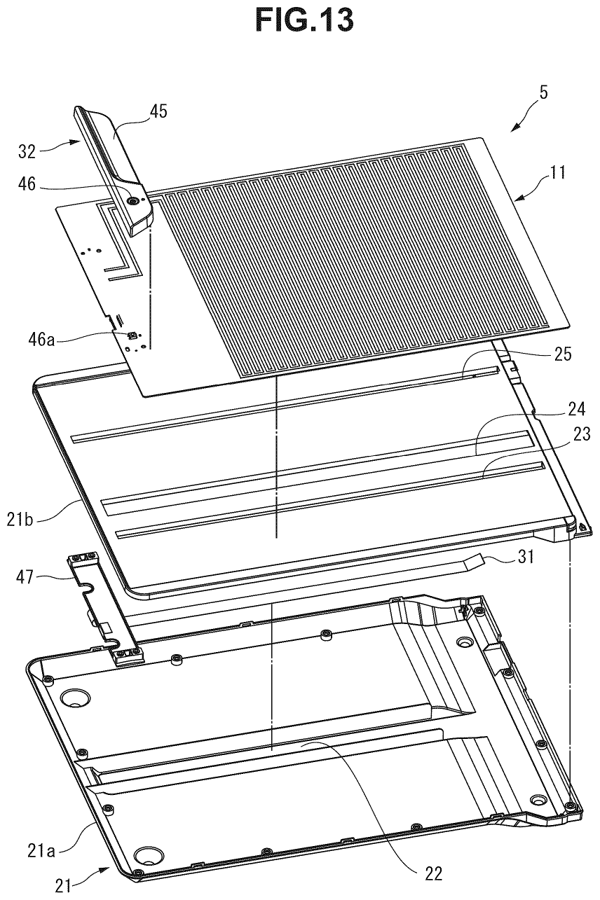

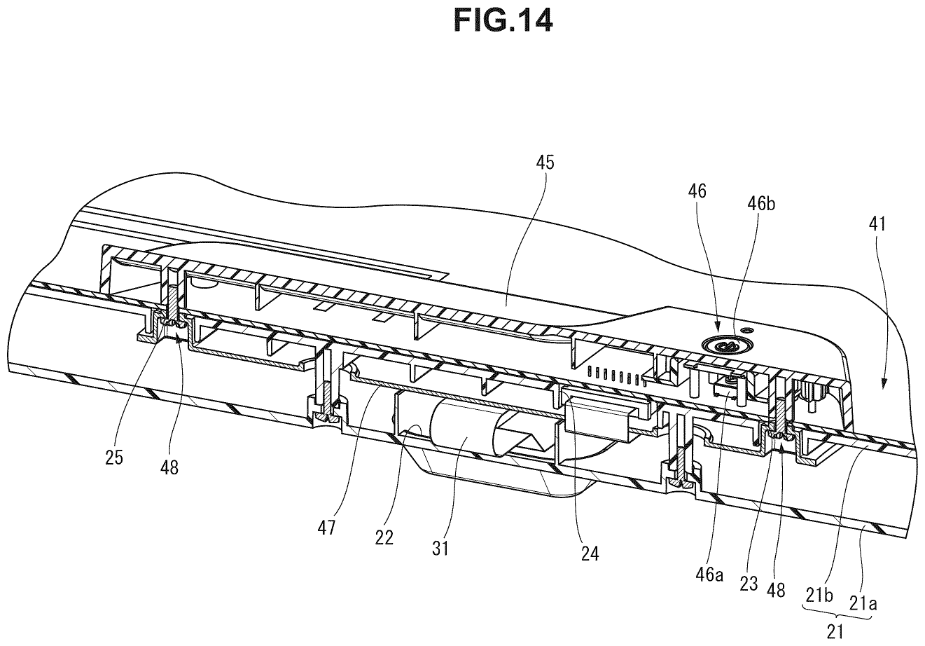

The support 21 is formed to be seen as a rectangular box extending in the front-rear direction and the left-right direction when viewed from above. As shown in FIGS. 13 and 14, the support 21 includes: a box-shaped bottom member 21a which is open toward upwards; and a upper surface plate 21b which closes the opening of the bottom member 21a, and a hollow box is formed by the bottom member 21a and the upper surface plate 21b. A groove 22 extending in the front-rear direction is formed on the central portion of the bottom member 21a in the left-right direction.

The upper surface of the upper surface plate 21b constitutes a placing surface on which the electrostatic chucking mat 11 described later is placed. The placing surface is formed flat such that the electrostatic chucking mat 11 can slide and move thereon. The placing surface is parallel to the surface of the work stage 3, and the placing surface and the surface of the work stage 3 are flush with each other. Moreover, first to third elongated holes 23-25 extending in the front-rear direction are formed on the upper surface plate 21b. The first to third elongated holes 23-25 are holes for passing accessory parts, described later, of the electrostatic chucking mat 11.

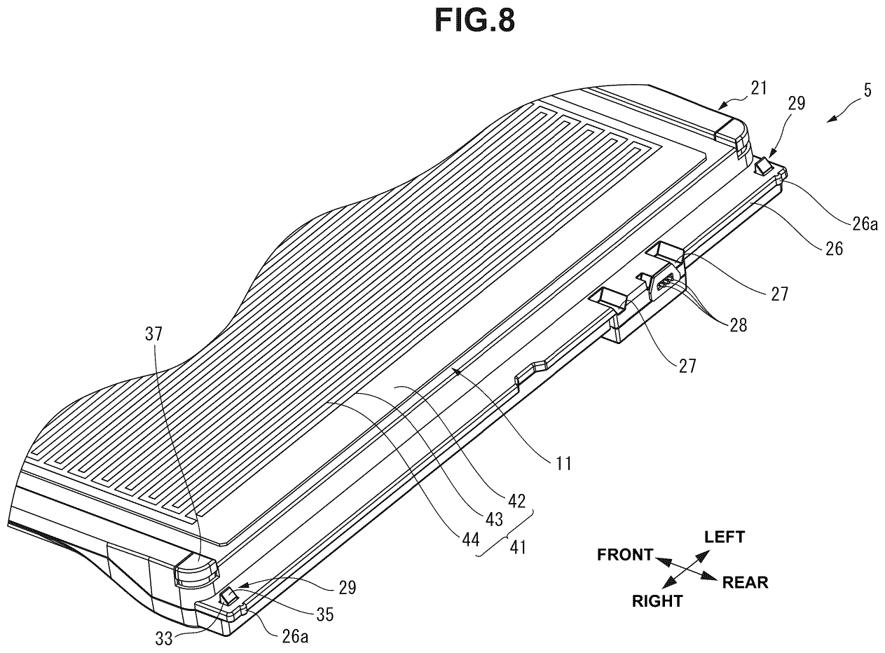

As shown in FIG. 8, a connecting piece 26 extending in the left-right direction is formed on the rear end of the support 21. The connecting piece 26 is a portion that is inserted into the groove 13 of the cutting plotter 1 when attaching the medium supporting device 5 to the cutting plotter 1. The connecting piece 26 serves as a connecting portion connected to the cutting plotter 1. The support 21 is removably connected to the cutting plotter 1 via the connecting piece 26.

Two recesses 27 (first structure) and a first contact terminal 28 are formed on an intermediate portion of the connecting piece 26 in the left-right direction. Moreover, two locking mechanisms 29 are formed on both ends of the connecting piece 26 in the left-right direction.

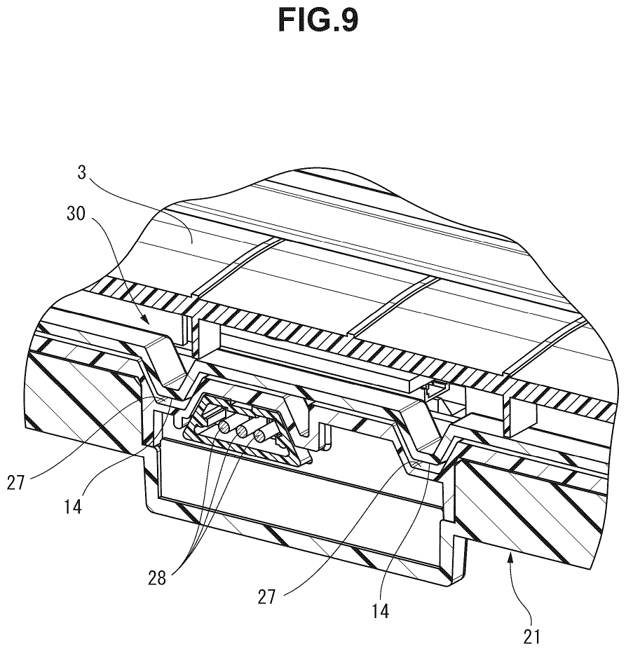

The two recesses 27 constitute a positioning structure 30 together with two protrusions 14 formed on the groove 13 of the cutting plotter 1, as shown in FIG. 9. The positioning structure 30 is configured to position the support 21 in a correct position with respect to the cutting plotter 1 in the left-right direction. The recess 27 has a shape that mates with the protrusion 14 of the cutting plotter 1. That is, the connecting portion between the cutting plotter 1 and the support 21 includes a positioning structure 30 for determining the position of the support 21 with respect to the cutting plotter 1 by fitting the protrusion 14 to the recess 27.

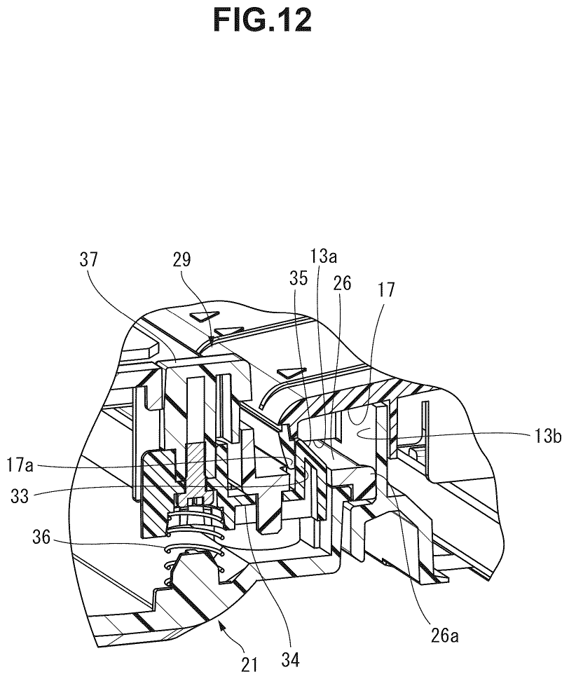

The positioning of the support 21 with respect to the cutting plotter 1 in the front-rear direction is carried out by abutting the rear end 26a of the connecting piece 26 against the bottom wall 13b of the groove 13 as shown in FIG. 12.

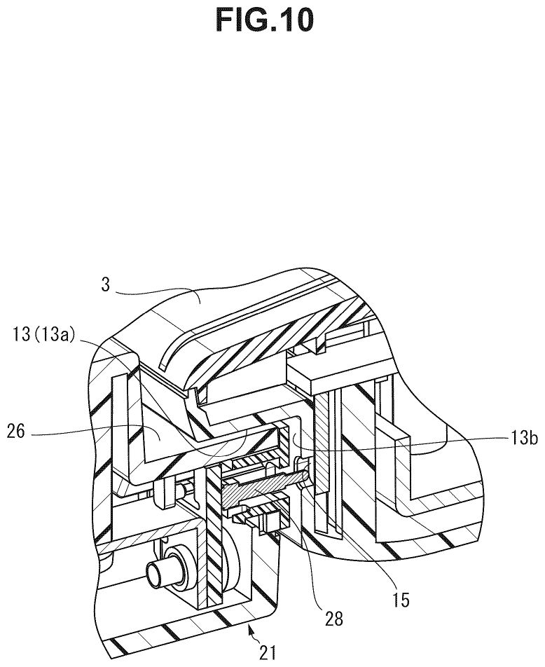

The first contact terminal 28 is constituted by a plurality of pins (see FIG. 10) which protrude rearward from the connecting piece 26 for supplying power to the electrostatic chucking mat 11. FIG. 10 shows a state in the middle of the process of connecting the support 21 to the cutting plotter 1. The first contact terminal 28 is electrically connected to the electrostatic chucking mat 11 via a flexible cable 31 (see FIG. 13) extending in the front-rear direction in the support 21. Although not illustrated in detail, the pin constituting the first contact terminal 28 is configured to be moveable to advance and retreat in the front-rear direction, and is biased toward rearward by the spring member.

As a result of the support 21 being connected to the cutting plotter 1, the first contact terminal 28 of the support 21 is connected to the second contact terminal 15 of the cutting plotter 1. As a result of the support 21 being removed from the cutting plotter 1, the first contact terminal 28 is isolated from the second contact terminal 15.

The flexible cable 31 is flexible for allowing movement of the electrostatic chucking mat 11, and is accommodated in a groove 22 extending in the front-rear direction on the bottom of the interior of the support 21. An end of the flexible cable 31 on the cutting plotter 1 side is connected to the first contact terminal 28, and an end on the electrostatic chucking mat 11 side is connected to a switch portion 32 (see FIGS. 5-7), described later, of the electrostatic chucking mat 11.

The locking mechanism 29 is for preventing the support 21 connected to the cutting plotter 1 from disengaging from the cutting plotter 1. The locking mechanism 29 according to this embodiment includes an engagement piece 34 that engages an engagement hole 17 formed on the cutting plotter 1. The engagement piece 34 includes a claw 33 (protrusion) protruding upward from the connecting piece 26 as shown in FIG. 11. The claw 33 is inserted into and removed from the hole 17 of the cutting plotter 1. An inclined surface 35 that goes up when approaching forward is formed on the upper end of the claw 33 that slopes forward as shown in FIG. 8. In other words, the claw 33 has a rear end of the support 21 or an upper surface that goes down towards the cutting plotter 1.

The engagement piece 34 is supported by the support 21 movably in the up-down direction, in other words, in a direction in which the engagement hole 17 of the cutting plotter 1 extends. A compression coil spring 36 (spring) is provided between the engagement piece 34 and the inner bottom surface of the support 21. The compression coil spring 36 biases the engagement piece 34 in the upward direction, that is, a direction in which the claw 33 enters into the engagement hole 17.

A manipulating piece 37 exposed onto the upper surface of the support 21 is attached to the upper end of the engagement piece 34. The manipulating piece 37 is for pressing the engagement piece 34 downward. The engagement piece 34 is lowered as a result of the manipulating piece 37 being pressed downward against the spring force of the compression coil spring 36.

In this locking mechanism 29, the inclined surface 35 of the claw 33 abuts an opening edge 17a (see FIG. 11) of the engagement hole 17 when the support 21 approaches the cutting plotter 1 from the front. As the support 21 advances further, the inclined surface 35 slides with respect to the opening edge 17a of the engagement hole 17, and the claw 33 is pushed downward.

Thereafter, when the claw 33 passes below the opening edge 17a of the engagement hole 17, the engagement piece 34 rises by the spring force of the compression coil spring 36, and the claw 33 enters into the engagement hole 17 (see FIG. 12). As a result of the claw 33 entering the engagement hole 17, the engagement piece 34 engages the engagement hole 17, and the support 21 cannot be disengaged forward from the cutting plotter 1.

In order to disengage the support 21 from the cutting plotter 1, the manipulating piece 37 is pressed down against the spring force of the compression coil spring 36. As a result of the manipulating piece 37 being pressed down, the engagement piece 34 is lowered, and the claw 33 is lowered from the opening edge 17a of the engagement hole 17, cancelling the engaged state. By pulling the support 21 forward in this situation, the medium supporting device 5 can be removed from the cutting plotter 1.

The electrostatic chucking mat 11 is configured by attaching a plurality of functional components to a printed wiring board 41 as shown in FIG. 5. The printed wiring board 41 includes: a substrate 42 formed of a hard plastic material; and first and second electrode patterns 43 and 44 constituted by conductor patterns formed by photolithography on a front surface of the substrate 42. Although not illustrated, the surfaces of the substrate 42 and the first and second electrode patterns 43 and 44 are covered with a protective film made of a hard material. The printed wiring board 41 is placed on the support 21 and is supported by the support 21 movable in the front-rear direction.

Each of the first and second electrode patterns 43 and 44 is formed in a shape of teeth of a comb. Specifically, the first electrode pattern 43 includes: a large number of body portions 43a which extend linearly in the left-right direction from one end to the other end of the substrate 42 in the left-right direction; and a connecting portion 43b which connects the left ends of the body portions 43a with each other. The second electrode pattern 44 includes: a large number of body portions 44a which extend linearly in the left-right direction from one end to the other end of the substrate 42 in the left-right direction; and a connecting portion 44b which connects the right ends of the body portions 44a with each other. The body portion 43a of the first electrode pattern 43 and the body portion 44a of the second electrode pattern 44 are alternately arranged at predetermined intervals in the front-rear direction. As a result of being energized by the first electrode pattern 43 and the second electrode pattern 44, an electrostatic chucking force is generated in a region where the body portions 43a and 44a are formed on the substrate 42.

The first electrode pattern 43 and the second electrode pattern 44 are connected to the switch portion 32 located at the front end of the printed wiring board 41 by the wiring portions 43c and 44c, respectively. As shown in FIG. 14, the switch portion 32 includes: a housing 45 provided on the upper surface of the printed wiring board 41; and an ON/OFF switch 46.

As shown in FIGS. 13 and 14, the housing 45 faces the support plate 47 provided inside the support 21, via the printed wiring board 41 and the upper surface plate 21b of the support plate 21. The housing 45 is connected to the support plate 47 by a bolt 48 (fastening member) that passes through the first slot 23 and the third slot 25 formed on the upper surface plate 21b. As a result of the printed wiring board 41 being sandwiched between the housing 45 and the support board 47 in this way, the housing 45 is fixed onto the printed wiring board 41.

The ON/OFF switch 46 includes: a switch body 46a mounted on the printed wiring board 41; and an operation button 46b supported by the housing 45 movable in the up-down direction. As a result of the operation button 46b pressed down, the switch body 46a is switched on and off.

The wiring portions 43c and 44c of the first and second electrode patterns 43 and 44 described above and the end portion of the flexible cable 31 on the electrostatic chucking mat 11 side are connected to the ON/OFF switch 46. As shown in FIG. 14, the end of the flexible cable 31 on the electrostatic chucking mat 11 side is raised upward from the groove 22 of the support 21 to be supported by the support plate 47. The open end side of the flexible cable 31 from the support plate 47 passes through the second elongated hole 24 on the upper surface plate 21b and is connected to a wiring pattern, not illustrated, for power supply on the printed wiring board 41, and is connected to the switch body 46a via the wiring pattern for power supply.

The ON/OFF switch 46 switches between a state in which the flexible cable 31 and the first and second electrode patterns 43 and 44 are electrically connected to each other and a state in which conductivity between the flexible cable 31 and the first and second electrode patterns 43 and 44 is interrupted. As a result of the ON/OFF switch 46 being switched on while the support 21 is attached to the cutting plotter 1, the first and second electrode patterns 43 and 44 are energized from the power supply unit 16 of the cutting plotter 1 via the second contact terminal 15, the first contact terminal 28, the flexible cable 31, and the switch body 46a.

In order to cut a thin medium 2 using the cutting plotter media supporting device 5 configured in this manner, the media supporting device 5 is first attached to the cutting plotter 1. This attachment is carried out by inserting the connecting piece 26 of the support 21 into the groove 13 of the cutting plotter 1 from the front. At this time, the protrusion 14 of the cutting plotter 1 fits into the recess 27 on the connecting piece 26, so that the support 21 is positioned in the left-right direction with respect to the cutting plotter 1, and the connecting piece 26 abuts the bottom wall 13b of the groove 13, so that the support 21 is positioned in the front-rear direction with respect to the cutting plotter 1. As a result of the support 21 being attached to the cutting plotter 1, the first contact terminal 28 on the connecting piece 26 is connected to the second contact terminal 15 of the cutting plotter 1. Moreover, the locking mechanism 29 prevents the support 21 from disengaging from the cutting plotter 1.

Next, the protective sheet 12 is placed on the electrostatic chucking mat 11 to cover the electrostatic chucking mat 11 (substrate 42), and the medium 2 is placed on the protective sheet 12. The protective sheet 12 is formed of a material that is softer than the material of the substrate 42 of the electrostatic chucking mat 11. For example, the protective sheet 12 may be formed of vinyl chloride. As a result of sandwiching the protective sheet 12 between the electrostatic chucking mat 11 and the medium 2, it is possible to prevent a blade of the cutting pen from coming into contact with the surface of the electrostatic chucking mat 11 and from being worn during cutting.

Thereafter, the ON/OFF switch 46 on the electrostatic chucking mat 11 is switched on. As a result of the ON/OFF switch 46 switched on, the first and second electrode patterns 43 and 44 of the electrostatic chucking mat 11 are energized to cause the protective sheet 12 and the medium 2 to be chucked onto the electrostatic chucking mat 11 by the electrostatic chucking force.

While the medium 2 is chucked onto the electrostatic chucking mat 11 in this manner, the electrostatic chucking mat 11 is slid rearward with respect to the support 21 to cause the rear end of the electrostatic chucking mat 11 to be sandwiched between the medium driving roller 6 and the pinch roller 7. Thereafter, the cutting operation by the cutting plotter 1 is started. During cutting, the electrostatic chucking mat 11 is driven by a medium feeding mechanism 8 constituted by the medium driving roller 6 and the pinch roller 7, and reciprocates multiple times in the front-rear direction with respect to the support 21.

The substrate 42 on the electrostatic chucking mat 11 is formed by a hard plastic material. Specifically, the substrate 42 may be formed of a material harder than the material of the protective sheet 12. Moreover, the electrostatic chucking mat 11 is supported by the support 21 constituting a surface that is flush with that of the work stage 3. Accordingly, the electrostatic chucking mat 11 is not bent during cutting. Therefore, it is possible to maintain a state in which the medium 2 is chucked onto the electrostatic chucking mat 11 by the electrostatic chucking force from the time when the cutting is started until the time when the cutting is finished. Thus, in accordance with this embodiment, it is possible to provide a medium supporting device 5 of the cutting plotter 1 capable of reliably cutting the thin medium 2.

The connecting portion between the cutting plotter 1 and the support 21 according to this embodiment includes a positioning structure 30 that determines the position of the support 21 with respect to the cutting plotter 1 as a result of the protrusion 14 fitting into the recess 27. Therefore, the medium supporting device 5 can always be mounted on a fixed position with respect to the cutting plotter 1. For this reason, for example, even when a plurality of types of media supporting devices 5 with different lengths in the front-rear direction are used, the cutting conditions can be the same for all media supporting devices 5.

In this embodiment, an example is shown in which the positioning structure 30 is configured by a protrusion 14 on the cutting plotter 1 and a recess 27 on the support 21, but the present invention is not limited thereto. A protrusion may be formed as a first structure on the connecting piece 26 of the support 21, a recess may be formed as a second structure on the groove 13 of the cutting plotter 1, and a positioning structure may be formed by such protrusion and the recess.

The connecting portion between the cutting plotter 1 and the support 21 according to this embodiment includes a second contact terminal 15 on the side of the cutting plotter 1 and which is connected to the power supply 16 of the cutting plotter 1, and a first contact terminal 28 on the side of the support 21 and which is electrically connected to the electrostatic chucking mat 11. Accordingly, the first and second contact terminals 28, 15 are automatically connected to each other in conjunction with the operation of attaching the support 21 to the cutting plotter 1. Therefore, there is no need to connect or disconnect an electrical system, and handling of the medium supporting device 5 becomes easier.

The electrostatic chucking mat 11 according to this embodiment includes: a substrate 42 movably supported by the support 21; and first and second electrode patterns 43 and 44 constituted by wiring patterns provided on the substrate 42. The first and second electrode patterns 43, 44 are electrically connected to the first contact terminal 28 by a flexible cable 31 that allows the electrostatic chucking mat 11 to move. The flexible cable 31 is housed inside the support 21. Therefore, since the wiring does not appear in the appearance of the device when the electrostatic chucking mat 11 is moved while the electrostatic chucking mat 11 is energized, a medium supporting device 5 with excellent appearance can be provided.

The media supporting device 5 according to this embodiment includes a locking mechanism 29 for preventing the support 21 from disengaging from the cutting plotter 1 while being attached to the cutting plotter 1. Therefore, even if the support 21 is pressed by friction resistance when the electrostatic chucking mat 11 moves reciprocally with respect to the support 21 during cutting, the support 21 does not move with respect to the cutting plotter 1. As a result, it is possible to make the support of the electrostatic chucking mat 11 stable, and carry out higher quality cutting.

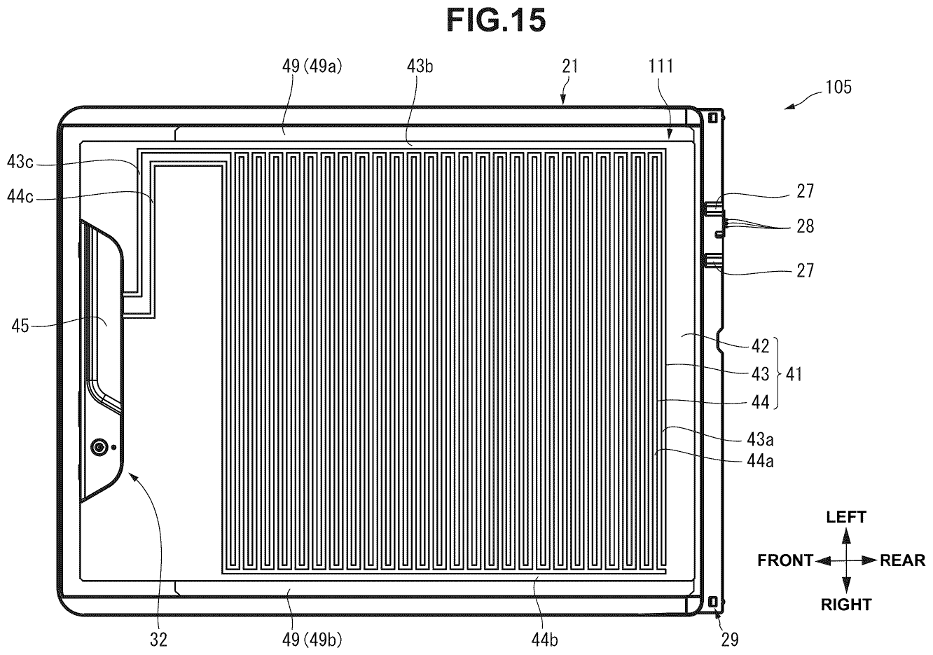

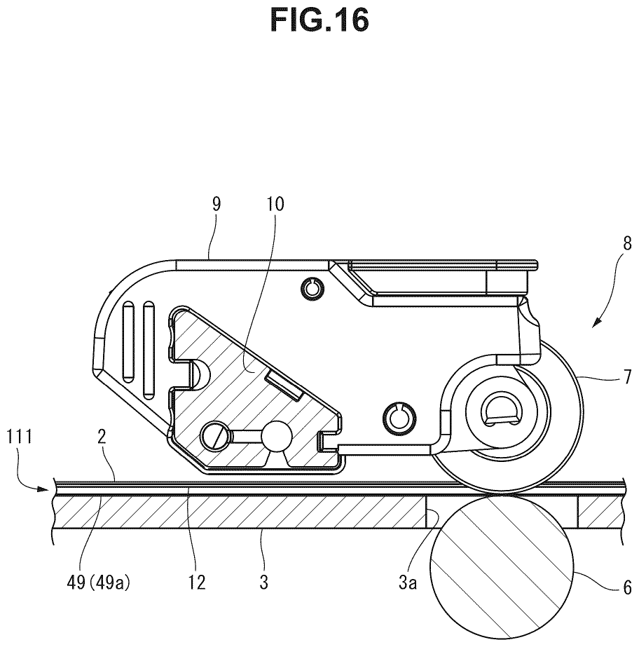

Other embodiments of the present invention will now be described with reference to FIGS. 15 and 16. In these figures, the same reference sign is assigned to the same member or a corresponding member shown in FIGS. 1-14, and the description thereof will be omitted as appropriate.

The medium supporting device 105 of the cutting plotter illustrated in FIG. 15 is different from the medium supporting device 5 illustrated in FIG. 1 in the electrostatic chucking mat. The electrostatic chucking mat 111 of the media supporting device 105 further includes a drive film 49 affixed to the back surface of the substrate 42. Both ends 49a and 49b of the drive film 49 in the left-right direction protrude outward from both ends of the substrate 42 in the left-right direction. This results in a structure in which the drive films 49a and 49b having predetermined widths in the left-right direction are attached to both ends of the substrate 42 in the left-right direction. The drive film 49 may be formed by, for example, Mylar (registered trademark).

The drive film 49 is thinner than the substrate 42 on the electrostatic chucking mat 111. For this reason, the electrostatic chucking mat 111 onto which the medium 2 is chucked can be moved in the conveyance direction by causing both ends 49a and 49b of the drive film 49 to be sandwiched between the medium driving roller 6 and the pinch roller 7 in the same way as the medium 2 such as paper, as shown in FIG. 16. Thus, the electrostatic chucking mat 111 onto which the medium 2 is chucked can be stably reciprocated in the same way as the medium 2 such as paper.

Appendices summarizing the above-mentioned embodiments will be described below. Elements in the Appendices below can be combined with each other.

Appendix 1 concerns a cutting plotter medium supporting device comprising: a support configured to be removably connected to a cutting plotter provided with a medium feeding mechanism configured to reciprocally move a medium in a first direction; an electrostatic chucking mat configured to be supported by the support movably in the first direction and generate an electrostatic chucking force by being energized, the electrostatic chucking mat being moved by the medium feeding mechanism while the medium is chucked by the electrostatic chucking force.

Appendix 2 concerns the medium supporting device according to Appendix 1, wherein the support includes a connecting portion connected to the cutting plotter.

Appendix 3 concerns the medium supporting device according to Appendix 2, wherein the connecting portion includes a first structure configured to mate with a second structure provided on the cutting plotter. The first structure may include a recess configured to mate with a protrusion constituting the second structure. The first structure may include a protrusion configured to mate with a recess constituting the second structure. The first structure and the second structure constitute a positioning structure that determines the position of the support relative to the cutting plotter. The positioning structure determines the position of the support with respect to the cutting plotter as a result of the protrusion fitting into the recess.

Appendix 4 concerns the medium supporting device according to Appendix 2 or 3, wherein the connecting portion includes a first contact terminal connected to a second contact terminal of the cutting plotter, the first contact terminal is electrically connected to the electrostatic chucking mat, and the second contact terminal is connected to a power supply of the cutting plotter. As a result of the support being connected to the cutting plotter, the first contact terminal is connected to the second contact terminal, and as a result of the support being removed from the cutting plotter, the first contact terminal is isolated from the second contact terminal.

Appendix 5 concerns the medium supporting device according to Appendix 4, wherein the electrostatic chucking mat includes: a substrate movably supported by the support; and an electrode pattern formed on the substrate, and the medium supporting device further comprises a flexible cable electrically connecting the electrode pattern to the first contact terminal, and the flexible cable is housed inside the support.

Appendix 6 concerns the medium supporting device according to any one of Appendices 2 to 5, wherein the connecting portion includes a locking mechanism configured to prevent the support connected to the cutting plotter from disengaging from the cutting plotter, and the locking mechanism includes: an engagement piece supported movably in the up-down direction, the engagement piece being configured to engage with a hole which is formed on the cutting plotter and which is open to a downward direction; a spring configured to bias the engagement piece toward an upward direction; and a manipulating piece formed on the engagement piece for pressing the engagement piece downward. The manipulating piece may be exposed to the upper surface of the support.

Appendix 7 concerns the medium supporting device according to Appendix 6, wherein the engagement piece includes a protrusion configured to be inserted into the hole on the cutting plotter and removed from the hole.

Appendix 8 concerns the medium supporting device according to Appendix 7, wherein the protrusion includes an upper surface that goes down as approaching the cutting plotter.

The engagement piece engages with the hole as a result of the support moving in a direction approaching the cutting plotter, and the engagement with the hole is cancelled as a result of the manipulating piece being operated.

Appendix 9 concerns the medium supporting device according to any one of Appendices 1 to 4, wherein the electrostatic chucking mat includes: a substrate movably supported by the support; and an electrode pattern formed on a front surface of the substrate.

Appendix 10 concerns the medium supporting device according to Appendix 9, further comprising a protective sheet placed on the electrostatic chucking mat. The medium is placed on the protective sheet. The protective sheet may be placed to cover the electrostatic chucking mat or the substrate. The protective sheet may be formed of a material that is softer than the material of the substrate. In other words, the substrate may be formed of a material harder than the material of the protective sheet.

Appendix 11 concerns the medium supporting device according to Appendix 9 or 10, wherein the electrostatic chucking mat further includes a drive film affixed to a back surface of the substrate, the drive sheet includes an end protruding outwardly from an end surface of the substrate in a second direction orthogonal to the first direction, and the drive film has a thickness thinner than a thickness of the substrate.

Appendix 12 concerns the medium supporting device according to Appendix 11, wherein the medium feeding mechanism includes: a drive roller extending in the second direction; and a pinch roller configured to move the medium by sandwiching the medium between the drive roller and the pinch roller, wherein the electrostatic chucking mat is configured to move by the end of the drive film being sandwiched between the drive roller and the pinch roller.

Appendix 13 concerns a cutting plotter comprising: the medium supporting device according to any one of Appendices 1 to 12; the medium feeding mechanism; a work stage detachably connected to the support of the medium supporting device; and a pen carriage configured to move above the work stage in a second direction which is orthogonal to the first direction and which is parallel to a horizontal direction and support a cutting pen movable in an up-down direction, wherein the medium feeding mechanism is configured to cause the electrostatic chucking mat on which the medium is chucked by the electrostatic chucking force to move reciprocally in the first direction.

The support may include a placement surface on which the electrostatic chucking mat is placed. The cutting plotter may include a work stage on which the medium is conveyed. The placement surface may be configured to be flush with the surface of the work stage. In other words, the placement surface may be parallel to the surface of the work stage.

This application claims the benefit of foreign priority to Japanese Patent Application No. JP 2023-147624, filed Sep. 12, 2023, which is incorporated by reference in its entirety.

1. A cutting plotter medium supporting device comprising:
a support configured to be removably connected to a cutting plotter provided with a medium feeding mechanism configured to reciprocally move a medium in a first direction; and
an electrostatic chucking mat configured to be supported by the support movably in the first direction and generate an electrostatic chucking force by being energized, the electrostatic chucking mat being moved by the medium feeding mechanism while the medium is chucked by the electrostatic chucking force.

2. The medium supporting device according to claim 1, wherein
the support includes a connecting portion connected to the cutting plotter.

3. The medium supporting device according to claim 2, wherein
the connecting portion includes a first structure configured to mate with a second structure provided on the cutting plotter.

4. The medium supporting device according to claim 2, wherein
the connecting portion includes a first contact terminal connected to a second contact terminal of the cutting plotter,
the first contact terminal is electrically connected to the electrostatic chucking mat, and
the second contact terminal is connected to a power supply of the cutting plotter.

5. The medium supporting device according to claim 4, wherein
the electrostatic chucking mat includes:
a substrate movably supported by the support; and
an electrode pattern formed on the substrate, and
the medium supporting device further comprises a flexible cable electrically connecting the electrode pattern to the first contact terminal, and the flexible cable is housed inside the support.

6. The medium supporting device according to claim 2, wherein
the connecting portion includes a locking mechanism configured to prevent the support connected to the cutting plotter from disengaging from the cutting plotter,
the locking mechanism includes:
an engagement piece supported movably in the up-down direction, the engagement piece being configured to engage with a hole which is formed on the cutting plotter and which is open to a downward direction;
a spring configured to bias the engagement piece toward an upward direction; and
a manipulating piece formed on the engagement piece for pressing the engagement piece downward.

7. The medium supporting device according to claim 6, wherein
the engagement piece includes a protrusion configured to be inserted into the hole on the cutting plotter and removed from the hole.

8. The medium supporting device according to claim 7, wherein
the protrusion includes an upper surface that goes down as approaching the cutting plotter.

9. The medium supporting device according to claim 1, wherein
the electrostatic chucking mat includes:
a substrate movably supported by the support; and
an electrode pattern formed on a front surface of the substrate.

10. The medium supporting device according to claim 9, further comprising
a protective sheet placed on the electrostatic chucking mat.

11. The medium supporting device according to claim 9, wherein
the electrostatic chucking mat further includes a drive film affixed to a back surface of the substrate,
the drive sheet includes an end protruding outwardly from an end surface of the substrate in a second direction orthogonal to the first direction, and
the drive film has a thickness thinner than a thickness of the substrate.

12. The medium supporting device according to claim 11, wherein
the medium feeding mechanism includes:
a drive roller extending in the second direction; and
a pinch roller configured to move the medium by sandwiching the medium between the drive roller and the pinch roller, wherein
the electrostatic chucking mat is configured to move by the end of the drive film being sandwiched between the drive roller and the pinch roller.

13. A cutting plotter comprising:
the medium supporting device according to claim 1;
the medium feeding mechanism;
a work stage detachably connected to the support of the medium supporting device; and
a pen carriage configured to move above the work stage in a second direction which is orthogonal to the first direction and which is parallel to a horizontal direction and support a cutting pen movable in an up-down direction, wherein
the medium feeding mechanism is configured to cause the electrostatic chucking mat on which the medium is chucked by the electrostatic chucking force to move reciprocally in the first direction.
